(19) United States
(12) Patent Application Publication
(10) Pub. No.: US 2007/0181217 A1
(43) Pub. Date: Aug. 9, 2007

(54) Tree climbing and cutting apparatus

(76) Inventor: Ned Ahdoot, Rancho Palos Verdes, CA (US)

Correspondence Address: PATENT LAW & VENTURE GROUP, 2424 S.E. BRISTOL, SUITE 300, NEWPORT BEACH, CA, 92660, US

(21) Appl. No.: 11/347,466

(22) Filed: Feb. 3, 2006

(51) Int. Cl. B27L 1/00; A01G 23/095; B27M 3/00

(52) U.S. Cl. 144/208.2; 144/24.13

(57) ABSTRACT

A split support ring having two halves joined by a hinge is mounted about a tree. A trolley is mounted on the support ring and movable horizontally in all positions over 360 angular degrees. A plurality of wheel assemblies are paced around the support ring and depend downwardly providing wheels angularly positionable into contact with the tree for supporting and moving the support ring vertically on the tree. A tension device in contact with the wheel assemblies causes the wheels to gain traction against the tree. A saw is mounted on the trolley, the saw engaged so as to move in mutually orthogonal directions for positioning the saw as needed in cutting into the tree and its branches or fronds.

### CROSS-REFERENCE TO RELATED APPLICATIONS

Not applicable

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTTED ON A COMPACT DISC

Not applicable.

### REFERENCE TO A “MICROFICHE APPENDIX”

Not applicable.

### BACKGROUND OF THE INVENTION

### Field of the Present Disclosure

This disclosure relates generally to tree trimming devices in general and more specifically to an apparatus that is self-propelled and climbs trees while cutting fronds or branches with various types of cutting devices.

### BACKGROUND ART

Previously, various mechanical devices have been used for providing a means to climb and remove limbs of standing trees. A search of the prior art did not disclose any patents that possess the novelty of the instant invention, however the following U.S. patents are considered to be related art:

Clouston in U.S. Pat. No. 5,983,966 teaches a self-propelled tree pruning apparatus using a cutting tool with helical edges. The invention includes a frame, a pair of driven wheels and a pair of hugger wheels that are rotatably attached to the frame. Pneumatic air bags urge the hugger wheels toward the driven wheels, and the cutting tool is attached to a drive shaft which is also attached to the frame and is movable along three axes. A self-powered engine drives both the cutting tool and the driven wheels. The drive engine is throttled back to an idling speed and the pressure is released on the air bag when the device is to descend to the ground. U.S. Pat. No. 5,975,168 issued to Ericksson is for a trimming device that utilizes a harvester head positioned at a pre-selected transverse position relative to a tree trunk. A control device is movably connected to a tree trimming member selecting a transverse position relative to the tree trunk. An actuator urges a tree trunk engaging portion into engagement with the tree and the trimming member at the pre-selected transverse position. Barnhill, et al. in U.S. Pat. No. 5,524,685 discloses a debarking/declimbing apparatus having a rotatably driven spool device that removes bark as the tree parts are moved lengthwise across its axis. The spool device consists of a rotor which includes tooth elements with two spools used in concert. The debarking elements may be fixed in helical form or may be flexibly mounted and capable of assuming a near helical form. Fuminao in U.S. Pat. No. 4,690,184 teaches a tree pruning machine having a cutting unit mounted on a frame and wheels elevating vertically. A first member has drive wheels mounted on its lower portion that are driven by an engine; a chain saw is also rotated by the engine. A branch sensing member projects forward temporarily stopping the drive toward the upward direction of a standing tree. U.S. Pat. No. 4,527,603 issued to Hori is for an automatic lopping machine which has a body with a drive unit, a chain saw and a number of drive wheels. An auxiliary unit includes idle wheels connected together with the main body so as to encircle a tree trunk. The drive unit is used to drive the chain saw and the drive wheels when the machine revolves helically around the tree trunk when the machine ascends a tree trunk. Baxter Jr. in U.S. Pat. No. 3,545,509 discloses a tree harvester that converts standing trees into chips by delimbing the tree from the bottom to the top, debarking the trunk from the top to the bottom, and progressively converting the tree trunk into chips from the top down. The device uses chain saws with knives that produce chips with long fibers and direct the chips upwardly out of the path of the knives.

The related art described above discloses mechanical means for trimming branches and fronds from trees. However, the prior art fails to disclose a manually operated and supervised apparatus and fails to disclose the much simpler apparatus of the present disclosure which although less complex accomplishes the same work in less time and at a lower cost then any of the prior art devices. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

Many attempts have been made to trim trees remotely without the necessity of actually climbing the tree. This utility is particularly useful when removing fronds from palm trees, as it has always been very difficult to trim palms or cycads since the fronds have sharp needle like barbs on their ends that are connected to husks. Additionally, considerable dust, dirt, trash and even rodents such as tree rats live in the tops of these type of tree. The common procedure for trimming and/or dressing palm trees is to manually cutoff and remove the frond adjacent to the palm husk. This operation requires a mechanical hoist or some other method of lifting the trimmer to the area that is to be trimmed. In some cases, the trimming is manually accomplished by actually climbing the tree using climbing gear that is well known in the art. Regardless of how the work is accomplished, it is dangerous and liability increases the cost. Also, the work is labor intensive and the initial cost of elaborate lifting equipment is fairly high.

The present invention is a tree trimming apparatus having a split support ring of two halves joined by a hinge, the support ring positionable around a tree. A trolley is mounted on the support ring and movable horizontally in all positions over 360 angular degrees. A plurality of wheel assemblies are paced around the support ring and depend downwardly providing wheels angularly positionable into contact with the tree for supporting and moving the support ring coaxially on the tree. A tension device in contact with the wheel assemblies causes the wheels to gain traction against the tree. A saw is mounted on the trolley, the saw engaged so as to move into any position in 3-space.

Therefore the primary object of the invention is to utilize a mechanical, self-propelled trimmer that climbs the tree and trims the fronds using a revolving set of blades, which allows an operator to remain on the ground a safe distance away and remotely guide the trimmer in its climbing speed and its depth of cut.

An important object of the invention is directed to its safety aspect since the operator is completely removed from the area where the fronds fall, the operator is not precariously positioned during any phase of the trimming operation.

Another object of the invention is that the most current automation is employed, using motors that are many times smaller and more powerful than prior art equipment and are compact and deliver energy density exceeding internal combustion engines.

Still another object of the invention is the speed that a tree can be trimmed relative to the manual process. The operator simply attaches the inventive self-propelled climbing tree trimmer around the base of the tree and connects the trimmer to a utility power source or to a portable generator and stands clear while controlling the movement of the trimmer and depth of cut from a safe remote location on the ground. It is easily understood that the time to trim the tree is reduced to a fraction of the manual process.

Yet another object of the invention is the flexibility of the trimmer. Although the trimmer is primarily designed to be used with limb bearing trees, it may also be used on palm trees or cyaids or other trees that have small branches which are typically trimmed while the tree is still growing.

A further object of the invention is the ability of the trimmer to leave a palm tree with a uniform appearance as the uneven husks left on the tree after trimming in a conventional manner are completely eliminated, thus causing all adjacent trees to have the same uniform outward appearance. The invention is able to deliver a uniform, visual outside shape of the tree trunk with reliable repetition.

A further object of the present apparatus is to provide a highly simplified and relatively inexpensive device for trimming and cutting trees.

A further object of the invention is to provide a tree trimmer that is easily transported to remote areas not accessible to heavy machinery.

A further object of the invention is to carry tools and personnel on a tree trunk or on a pole.

These and other objects and advantages of the present invention will become apparent from the subsequent detailed description of the preferred embodiment and the appended claims taken in conjunction with the accompanying drawings.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of a first preferred embodiment of the present invention;

FIG. 2 is a perspective view of a second preferred embodiment thereof;

FIG. 3 is a perspective view of a third preferred embodiment thereof;

FIG. 4 is a perspective view of a fourth preferred embodiment thereof; and

FIG. 5 is a perspective view of a fifth preferred embodiment thereof.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

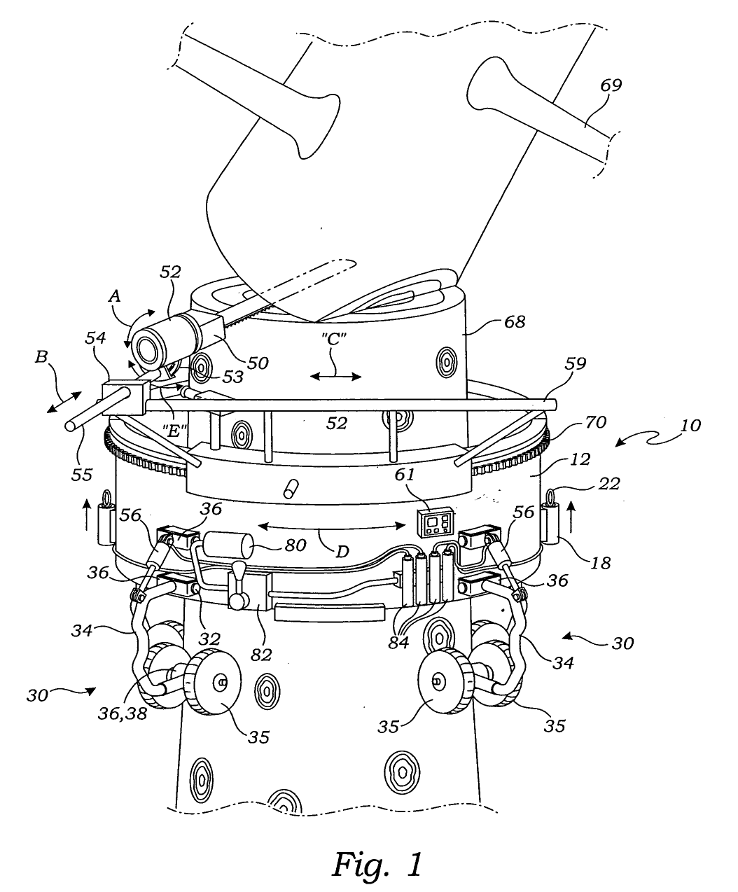

Described now in detail are the best modes for carrying out the invention as shown in FIGS. 1 thorough 5, for a self-propelled, tree climbing trimmer 10 that is used for severing fronds or branches from a tree 68 and for topping such tree. While the basic utility of this invention is for use with large trees including the common types harvested in the timber industry, other trees with relatively small branches or fronds, such as palm trees, may be trimmed using the present apparatus.

As shown in FIG. 1, the trimmer 10 consists of a hinged, split support ring 12 that is torus shaped as described in Van De Mortel U.S. Pat. No. 6,474,377 ('377) and which is hereby incorporated into this disclosure by reference. The support ring 12 is divided into two halves with a hinge 18 connecting the halves together permitting the support ring 12 to be placed axially around tree 68 as shown. The hinge 18 is disposed on an exterior peripheral wall 16 of the support ring 12 and is rotate one of the halves relative to the other sufficiently wide to position the invention around a tree trunk as illustrated. The hinge 18 may be any type of hinge and preferably includes a hinge pin 22 functional for connecting the two ring halves. Latching devices may be attached to the peripheral wall 16 as shown in the '377 reference, such that when the trimmer 10 is closed and the latches are manually secured, each half of the support ring 12 is positively fastened and secured to the other.

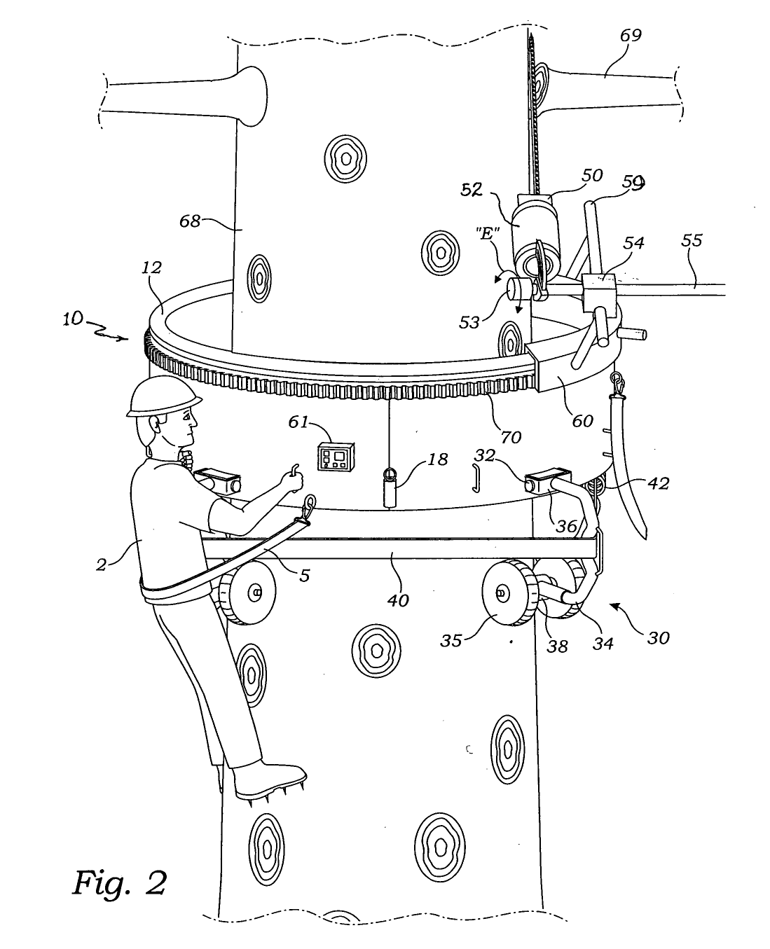

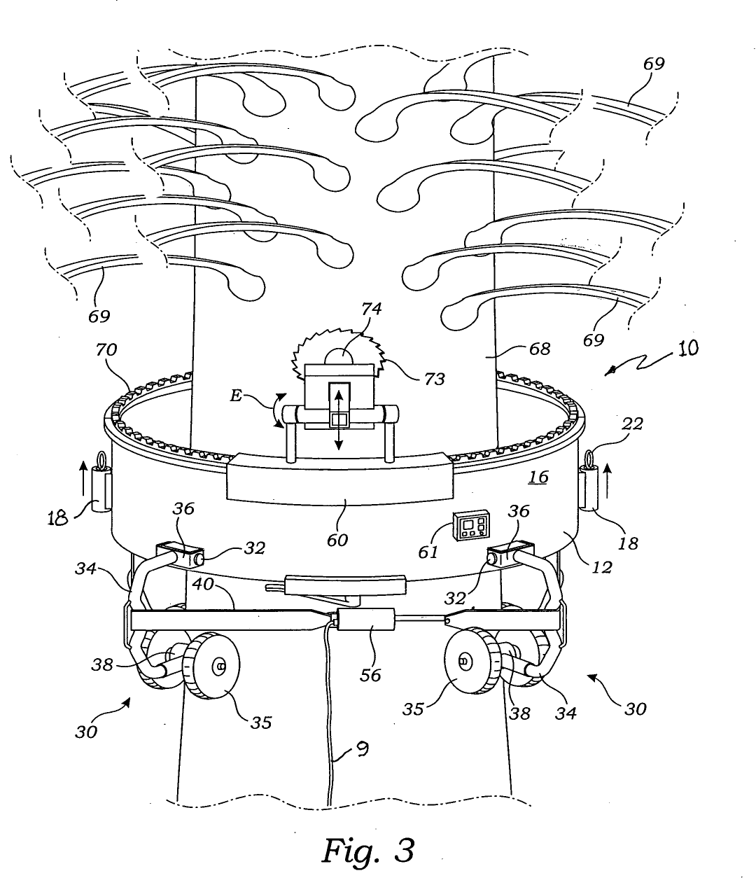

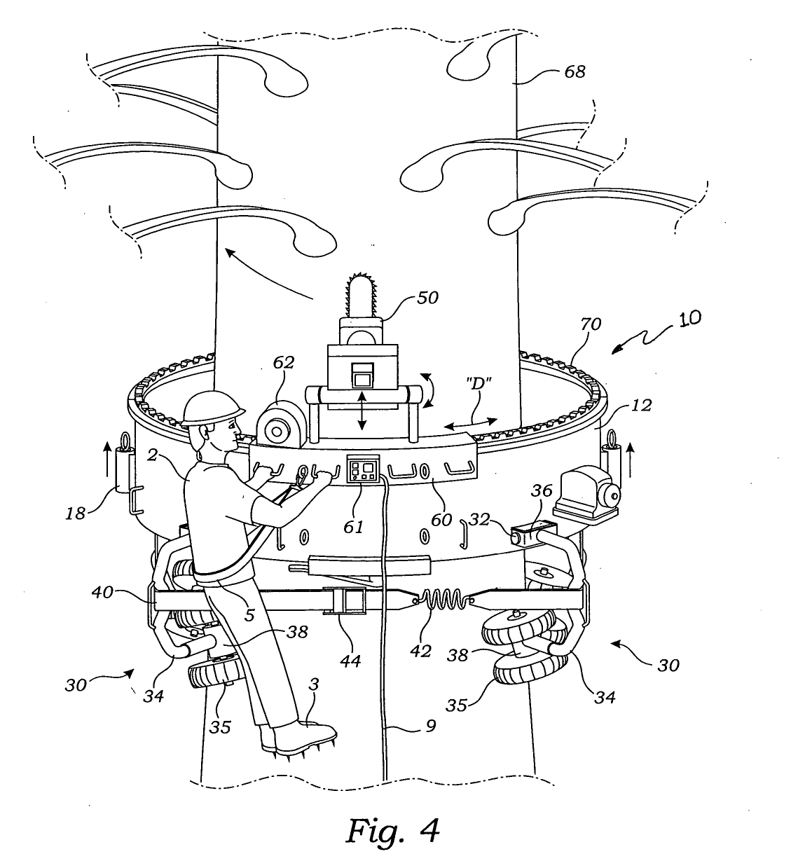

In the embodiments shown, a ring gear 70 is mounted on the exterior surface of support ring 12 and it may be placed on the exterior vertical surface 16 as shown in FIGS. 1 and 2, or on the top, up-facing surface as shown in FIGS. 3 and 4. The ring gear 70 is also split into two equal halves so that it may be parted along with the two halves of the support ring 12 when opened for engagement with or removal from tree 68.

The present invention may be manually operated or remotely operated through automation of any type that is well known in the art. It is not the automation fixtures or techniques that provide novelty herein, but rather the arrangement of the several elements of the invention that is both novel and particularly beneficial and novel with respect to the prior art, and in particular, the Van de Mortel disclosure.

In the embodiment of FIG. 1 a plurality of wheel assemblies 30 are attached by hinges 32 to the support ring 12. Each of these wheel assemblies 30 provides a frame 34 connecting a hinge yolk 36 to an axle 38 which mounts two wheels 35, as shown, although one wheel 35 in each assembly 30 or more than two wheels 35 may be utilized. Axle 38 provides an electric motor which drives wheels 35. A linear actuator 56 is used to provide tension for traction between wheels 35 and the tree 68. In FIG. 1 a hydraulic motor 80 is fixed to support ring 12 and through control box 82 it provides pressure to control valves 84 which control the actuators 56. Control from the ground level may be applied through control cables 9 or through radio signals to control box 61 which contains control circuits and transceiving circuits.

In the embodiments of FIGS. 2-4, the frames 34 are joined by a tension strap 40 which applies tension to the frames 34 to drive the wheels 35 against the tree 68. Preferably, the wheels 35 are set at an angle to the horizontal, as shown in FIG. 4, so that as the trimmer 10 is moved in rotational rolling motion around the tree 68, it also moves in spiral motion vertically. The tension strap 40 may be tensioned by spring 42 (FIGS. 2 and 4) or by a linear actuator 56 (FIG. 3) or any equivalent mechanism. Adjustment of strap 40 is initially made using buckle 44 (FIG. 4). As the trimmer 10 moves upwardly on tree 68, spring 42 tends to maintain tension force as the diameter of the tree 68 diminishes. The technician 2 must tighten the strap 40 periodically to assure proper traction of the wheels 35 with the tree surface. The wheels 35 may be set at a preferred angle manually or by remote control through a second motor within axle 38. The placement and utilization of motors for driving the wheels 35 and for setting their angle would be within the capability of one of skill in the art.

Referring now primarily to FIGS. 1 and 2, mounted on the ring 12 is a trolley 60 carrying a cutting device such as a chain saw 50 as shown in FIG. 1, a circular saw 74 as shown in FIG. 3, or any similar cutting device appropriate to the present apparatus for accomplishing its objective of trimming or cutting the tree 68. In FIG. 1 chain saw 50 is mounted on a first motor 52 which is able to position saw 50 in accordance with arrow “A”, i.e., a selected angle of cut. This motion is able to bring the saw 50 into contact with a limb 69 (FIG. 2) or with the tree trunk itself FIG. 1 at a desired angle. Rotational action is enabled by motor 53 shown in FIG. 2 (hidden in FIG. 1) for driving the saw in accordance with arrow “E”, i.e., to move the cutting blade in an arc in order to cut through the limb, etc. A third motor 54 containing two drive arrangements, drives the entire cutting package along shaft 55 in accordance with arrow “B” in a first orthogonal direction, and drives shaft 55 as well as the cutting package along shaft 59 to position the saw 50 in a second orthogonal direction as shown by arrow “C”, which is therefore able to position cutting package (motors 50, 52, and saw 53) as desired. The above described motors are preferably driven by gas, hydraulic or electric power as is well known in the art.

In a manual use of the present invention, as shown in FIG. 4, the technician 2 holds the trolley 60 stationary with respect to the tree 68 and is supported by his spiked shoes 3 and his safety strap 5 while the support ring 12 is driven spirally to provide climbing motion. The wheels 35 are driven by motors 38 so that the ring 12 is able to be driven in spiral motion up and down along the tree 68. Upon reaching a desired position on tree 68, the ring 12 is halted and the saw 50 is then positioned for cutting. The motion of the saw 50 for cutting then may be directed by the technician 2 through a hand held remote control device (not shown), or through an electrical control Box 61 via an electrical conductor, cable 9. In a fully manual version of the apparatus, the wheels 35 are pre-set at an angle, as shown in FIG. 4, and the ring is manually rotated by the technician, thereby forcing the ring 12 to move in spiral motion on the tree.

As shown in FIG. 4 the ring gear 70 engages motor 62 to enable motion of the trolley 60 in accordance with arrow “D”, i.e., trolley 60 is able to be driven to any position on ring 12. Motor 62, although present, is not shown in FIGS. 1-3 for clarity. In FIG. 3 we see that a circular saw blade 73 is used and this is particularly effective in removing palm tree fronds 69. This blade 73 is driven by motor 74 and is able to move in arcuate motion as defined by arrow “E”.

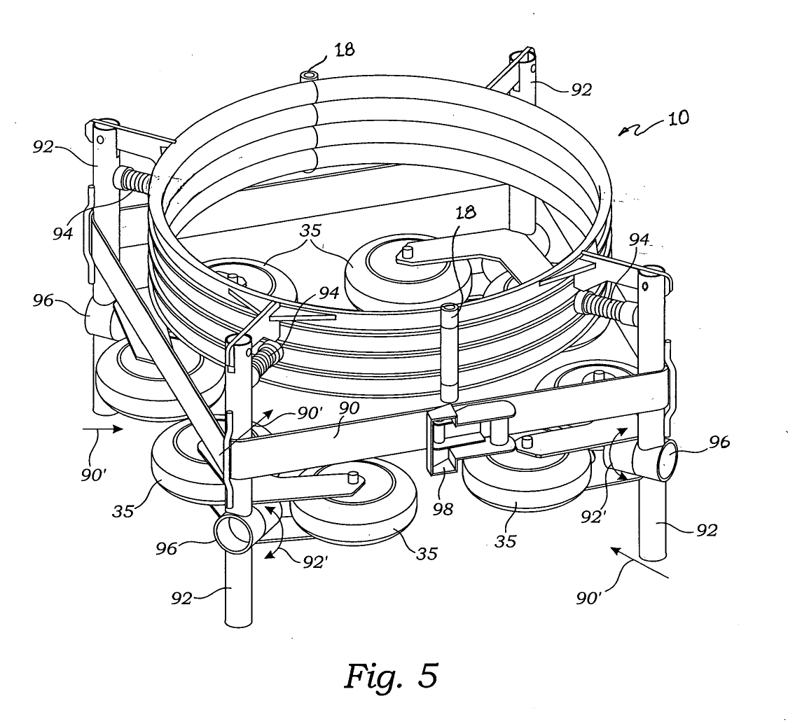

In a further embodiment shown in FIG. 5, strap 90 encircles four pivot bars 92 providing inwardly directed forces 90′ on bars 92 to drive wheels 35 against the tree 68. Springs 94 provide a counter force assuring that even pressure is applied by all eight wheels 35 and thereby assuring that the ring 12 is centered. Motors 96 provide rotation of the duel wheel sets mounted on each of the hinged bars 92 so as to set the wheels 35 at an angle to the horizontal for moving the apparatus vertically on the tree 68. Motors 96 are also adapted by drive chains or shafts (not shown) for rotating the wheels 35. Alternatively, in FIG. 5 the wheels 35 may each be driven by an axially mounted motor.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

1. A remote controlled tree and pole climbing apparatus for cutting trees, tree branches, palm tree leaves, and for carrying tools and equipment along a trunk of a tree or a pole, the apparatus comprising: a support ring, having two halves joined by a hinge and a lock, the ring positionable around a tree; a trolley mounted on the ring and movable circularly thereon; a plurality of hinged wheel assemblies spaced around the ring and depending downwardly therefrom, the wheel assemblies providing wheels positionable into contact with the tree for moving the ring in rotational rolling motion around the tree as it also moves in spiral motion vertically on the tree; a tension means in contact with the wheel assemblies causing the wheels to gain traction against the tree; a saw mounted on the trolley, the saw positionable about a vertical and two mutually orthogonal horizontal axes.

2. The apparatus of claim 1 wherein the base is made of plural, hingably joined sections circling the tree.

3. The apparatus of claim 1 wherein the trolley is engaged with a circular gear mounted on the support ring.

4. The apparatus of claim 1 wherein the tension means is a strap encircling the tree, the strap engaging the wheel assemblies in a manner for pressing the wheel assemblies against the tree.

5. The apparatus of claim 4 wherein the strap is engaged with a linear actuator enabling tightening of said strap.

6. The apparatus of claim 4 wherein the strap is engaged with a spring and buckle enabling manual tightening of said strap.

7. The apparatus of claim 1 wherein the tension means is at least one linear actuator engaged with each of the wheel assemblies.

8. The apparatus of claim 1 wherein the saw is a chainsaw.

9. The apparatus of claim 1 wherein the wheel assemblies each provide dual wheels having a common rotational axis, the wheels driven by an axially mounted motor.

10. The apparatus of claim 1 wherein the wheel assemblies each provide dual wheels having parallel mutually displaced rotational axis, each of the wheels driven by an axially mounted motor.

11. The apparatus of claim 10 wherein a tension strap encircles four pivot bars providing inwardly directed forces on the pivot bars thereby driving the wheels against the tree.

12. The apparatus of claim 11 further comprising tension springs positioned so as to apply a counter force to the pivot bars.

13. The apparatus of claim 1 wherein the saw is a circular saw.
